(19) United States
(12) Patent Application Publication
(10) Pub. No.: US 2023/0332987 A1
(43) Pub. Date: Oct. 19, 2023

(54) COMPOSITIONS FOR STAINING TISSUE AND METHODS OF MAKING THE SAME

(71) Applicant: Vector Surgical, LLC, Waukesha, WI (US)

(72) Inventor: Amanda Katsma, West Bend, WI (US)

(21) Appl. No.: 18/301,815

(22) Filed: Apr. 17, 2023

Related U.S. Application Data
(60) Provisional application No. 63/363,185, filed on Apr. 19, 2022.

(51) Int. Cl. G01N 1/30

(52) U.S. Cl. CPC G01N 1/30; G01N 2001/302

(57) ABSTRACT

Staining compositions and methods to stain a tissue are disclosed herein. The staining composition includes a diluent and a colorant comprising pigment particles having a D50 particle size of about 5 microns or less and a liquid carrier. The composition has a viscosity of about 10 Krebs Units or less. Using the staining composition, tissue may be stained directly at the point of excision from the patient in a minimum amount of time so that the specimen is identifiable and distinguishable at every point of risk from collection to analysis and reporting.

### CROSS-REFERENCE TO RELATED APPLICATION

This application claims the benefit of priority to U.S. Provisional Patent Application No. 63/363,185 filed Apr. 19, 2022, the entire contents of which are incorporated by reference herein.

### FIELD

The present disclosure generally relates to compositions that are useful in staining tissue specimens. The compositions may be of various colors and successfully adhere to tissue.

### BACKGROUND

Accreditation and regulatory organizations are focusing on improving processes related to patient identification and specimen labeling because frequent errors in these areas jeopardize patient safety. The typical biopsy specimen changes hands over 10 times from the point of collection to result reporting, creating a very long chain of custody with numerous points of vulnerability. Potential sources of errors in specimen identification include mislabeling of the container at the point of collection, mislabeling of the cassette and cutting board contamination during prosection contamination during processing, contamination or cassette mislabeling at embedding, water bath contamination “floaters” or slide mislabeling during microtomy, and slide contamination during staining. Most medical errors are the result of unavoidable human error.

To date, there is no easy way for health care professionals who handle specimens to distinguish between tissues from one specimen to the next, including distinguishing specimens from different locations in the same patient, or from two or more different patients. The absence of distinguishing characteristics of the tissue and consequent potential for error originates at the time of tissue collection from the patient and follows the specimen's journey through to the pathology lab, through processing and microscopic analysis, to final documentation of that analysis into the patient's electronic record. Biopsy mismatches can be a significant problem, and are often unrecognized within the medical field. See, e.g., McDonnell, M. M., et al., “Re: Biopsy Misidentification Identified by DNA Profiling in a Large Multicenter Trial,” European Urology, 60, 396 (2011); Makary, M. A., et al., “Surgical Specimen Identification Errors: A New Measure of Quality in Surgical Care,” Surgery, Vol. 141, No. 4, 450-455 (2007).

Patient information and bar codes on the patient wristband, specimen container, tissue cassette, and the microscopic slide have been implemented as a strategy to minimize and catch labeling errors. This approach attempts to maintain the fidelity of the secondary container labels and in certain circumstances alert the provider if there is a mismatch involving the paperwork, container, cassette, or slide scanned. However, it does not trigger an alert if there is an initial patient identification error upon registration or wristband scan, if the tissue identification is lost or switched with another specimen, or if any contaminants are introduced.

Another method for distinguishing high volume biopsy tissue and identifying tissue contaminants is the inking of the tissue at the time of prosecting. This method only identifies errors if the error occurs after macroscopic tissue examination and prosection. This method requires an estimated 20% more time per specimen to prosect, will not identify errors that occur during the pre-analytical phase of specimen procurement or handling, and risks contaminating the biopsy by touching it with ink applicators and obscuring the biopsy with thick ink.

Stains, particularly eosin, are frequently applied to biopsy specimens during prosection or processing to make the tissue easier to see during embedding and staining. This method improves the visibility and, therefore, survivability of the specimen during processing, but it does not improve the visibility of the tissue for the prosector who transfers the tissue from the initial container to the cassette, nor does it identify errors or cross contamination.

Accordingly, there is a need for tissue staining compositions that can be easily applied to high-risk soft tissue biopsy specimens at the point of collection, distinguishing the tissue throughout transport, processing, and final diagnosis reporting.

### SUMMARY

A tissue staining composition comprising a colorant and a diluent is disclosed. The colorant comprises pigment particles having a D50 particle size of about 5 microns or less and a liquid carrier. The composition may have a viscosity of about 10 Krebs Units or less. The colorant may be present in an amount of about 15% to about 50% by weight of the composition. The diluent may be water, and/or may be present in an amount of about 40% to about 75% by weight of the composition. The composition may include a binder, optionally present in greater than about 0% to about 35% by weight of the composition, and may comprise an acrylic resin, such as an alkali soluble styrene.

The tissue staining composition may include a dye, optionally in an amount of greater than about 0% to about 10% by weight of the composition, or it may include a solvent, a polymer, an ionically charged substance, a preservative, a surfactant, or any combination thereof. The composition may have a pH of about 7.75 to about 9.0.

The tissue staining composition, when stained on tissue and compared to tissue stained with a second staining composition of a different color, may have a Delta E of at least about 20, at least about 30, at least about 40, at least about 50 in reflected and/or transmitted light.

A method of staining a tissue is disclosed. The method comprises contacting the tissue with a staining composition comprising a diluent and a colorant comprising pigment particles having a D50 particle size of about 0.1 μm or less and a liquid carrier. The staining composition may have a viscosity of about 10 Kreb Units or less. The colorant may be present in the staining composition in an amount of about 15% to about 50% by weight of the composition. The tissue may be 1 cm or less, or about 5 mm or less at its greatest dimension. The method may include contacting the tissue with about 0.06 mL to about 0.29 mL of the staining composition, and/or contacting the tissue with a staining composition is done at the time of tissue collection.

The method may include: placing the stained tissue in a formalin solution, whereby the formalin solution is visibly tinted with the staining composition; and/or indicating on a document the color of the staining composition with which the tissue was marked, for example, by stamping the document with a bottle color label.

This disclosure relates to a kit comprising a bottle having a staining composition disposed therein, wherein the staining composition comprises a diluent and a colorant, and instructions. The colorant comprises pigment particles having a D50 particle size of about 5 microns or less and a liquid carrier. The diluent may comprise water, optionally present in an amount of about 40% to about 75% by weight of the composition. The kit may comprise a plurality of tissue staining compositions of a plurality of colors. The bottle may be a squeezable bottle, and/or include a bottle cap comprising a liquid dropper, and/or a stamper, optionally a self-inking stamper.

The staining composition may comprise a binder, optionally comprising an acrylic resin, such as an alkali soluble styrene, and/or have a viscosity of about 10 Krebs Units or less. The diluent may comprise water, optionally present in an amount of about 40% to about 75% by weight of the composition. The staining composition is capable of visibly staining a tissue to form a stained tissue and is capable of visibly tinting a formalin solution within 60 seconds of when the stained tissue is placed in the formalin solution.

### BRIEF DESCRIPTION OF THE DRAWINGS

The accompanying drawings, which are incorporated herein and constitute part of this specification, are illustrative of particular embodiments of the present disclosure and do not limit the scope of the present disclosure.

FIG. 1A is an image of an unmarked, translucent tissue within the drawn circle.

FIG. 1B includes images of the unmarked tissue from FIG. 1A and tissues stained with staining compositions of different colors of this disclosure.

FIG. 2A is an image of an unmarked tissue (left) in formalin transport medium and a tissue stained with a staining composition of this disclosure in formalin transport medium.

FIG. 2B includes images of the unmarked tissue from FIG. 2A and tissues stained with staining compositions of different colors of this disclosure in formalin transport medium.

FIG. 3A depicts an image of unmarked tissue embedded in paraffin for microtomy.

FIG. 3B depicts images of tissues stained with staining compositions of different colors of this disclosure embedded in paraffin.

FIG. 4A is an image of unmarked tissue viewed microscopically on a slide.

FIG. 4B includes images of tissues stained with staining compositions of different colors of this disclosure.

FIGS. 5A and 5B are images of a container disclosed herein having a stamp on the bottom of the container which may be used to provide color identification on documents for the patient record.

FIG. 6 depicts an example of a staining and identification system using the staining compositions disclosed herein where the staining compositions assist in serving as a patient identifier on the patient chart, container fluid, stained tissue, embedded tissue for microtomy, laboratory computer system, and slides.

FIG. 7 is a chart showing a scale for the macroscopic visualization of the stained tissue disclosed in Table 6.

FIG. 8 is a chart showing a scale for the macroscopic staining of the transport media once the stained tissue in Table 6 is placed therein.

FIG. 9 is a chart showing a scale for the microscopic visualization under transmitted light of the stained tissue disclosed in Table 6.

### DETAILED DESCRIPTION

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

It is also to be understood that the terminology used in the description is for the purpose of describing the particular versions or embodiments only and is not intended to limit the scope of the present disclosure which will be limited only by the appended claims. Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meanings as commonly understood by one of ordinary skill in the art. Although any methods, equipment, and materials similar or equivalent to those described herein can be used in the practice or testing of embodiments of the present disclosure, the preferred methods, devices, and materials are now described. All references mentioned herein are incorporated by reference in their entirety.

This disclosure is directed to staining compositions and methods to stain a tissue. Using such staining compositions, the tissue may be stained directly at the point of excision from the patient in a minimum amount of time so that the specimen is traceable, identifiable and distinguishable at every point of risk from collection to analysis and reporting. This will allow health care workers to avoid, identify, track, and correct errors well before they adversely affect patient care.

Accordingly, this disclosure is directed to a system having an identifier (the staining composition):
that is directly attached to the tissue at the point of collection;
that will stay with the specimen continuously from collection to result reporting; and
that increases the ability to see and process the tissue throughout specimen handling while minimizing error.

Making a successful staining composition requires an optimal balance between colorant and binder, diluent and binder, colorant and dye, and colorant and colorant. Without being bound by theory, the staining compositions disclosed herein achieve an optimal balance between all simultaneous competing requirements, including (1) secured adherence to tissue such that the tissue will be marked from the time of excision until at least the time of result reporting without staining too darkly such that the stained tissue is distinguishable from other colors of stained tissue; (2) spreading from the point of contact with the tissue to cover a maximum amount of the tissue surface; (3) surviving the rigors of chemical processing of the tissue; (4) readily visibly tinting the transport medium without infusing too much color, thereby obscuring the view of the tissue or degrading the color appearance of the tissue; and (5) imparting a color to the tissue that is recognizable and distinguishable when light is reflected off the tissue surface prior to, during, and after processing when perceived by the naked eye (reflected light), while simultaneously retaining a correlating color that is recognizable and distinguishable on the tissue surface under visible light, including after processing (reflected light) and as well as when light is passed through the stained tissue and viewed via a microscope (transmitted light). Additionally, the staining compositions disclosed herein will not substantially obscure the tissue histology or interfere with IHC or special stains. As an additional advantage, the staining compositions disclosed herein can adhere to the tissue quickly so as to minimize application time, preferably keeping application time to sixty seconds or less.

The staining compositions disclosed herein adhere to different tissue types to be used with different biopsy procedures. As used herein, the term “tissue” refers to any aggregation of similarly specialized mammalian cells which are united in the performance of a particular function, such as human tissue. The tissue may be any human tissue, such as, without limitation, soft tissue, fatty tissue, muscle tissue, bone tissue, serosa, connective tissue, or tissue from organs, such as heart, liver, lungs, brain, etc. The tissue for staining with a staining composition herein may be gastrointestinal tissue, esophageal tissue, breast tissue, prostate tissue, bone marrow cores, cervical tissue, dermatological tissue, or the like. The tissue may be minute, such as having a greatest dimension of about 1 cm or less, such as about 9 mm or less, about 8 mm or less, about 6 mm or less, about 5 mm or less, greater than 0 mm to about 10 mm, about 1 mm to about 10 mm, about 1 mm to about 8 mm, about 1 mm to about 5 mm, about 1 mm to about 5 mm, or a value within any of these ranges.

Using the staining compositions disclosed herein, tissue may be stained directly at the point of excision from the patient in a minimum amount of time so that the specimen is identifiable and distinguishable at every point of risk from collection to analysis and reporting. This will allow health care workers to avoid, identify, and correct errors before they adversely affect patient care. Using different colored staining compositions for different samples will allow health care professionals who handle specimens to easily distinguish between tissues from one specimen to the next, including distinguishing specimens from different locations in the same patient, or from two or more different patients.

### Colorant

The staining compositions disclosed herein include a colorant comprising pigment particles having a D50 particle size of about 5 microns or less and a liquid carrier; and a diluent; wherein the composition has a viscosity of about 10 Krebs Units or less. As used herein, the term “pigment” means the dry powder used to prepare and included in a colorant. As used herein, a “colorant” means pigment particles suspended in a liquid carrier. The colorant alters the color appearance of the staining composition on the tissue under both transmitted light and reflected light.

The staining composition may be a composition of any color. The staining composition may be a composition appearing as a color selected from blue, green, violet, red, orange, yellow, indigo, or black, or any shade thereof. The staining compositions disclosed herein include a colorant comprising a pigment.

The size of the pigment particles in the colorant must be in a certain size range (e.g. nanoparticle size) to create a color match both on reflected/macroscopic and transmitted/microscopic light when stained on a tissue. For example, the pigment particles may have a D50 particle size of about 8 microns or less, about 5 microns or less, about 4 microns or less, about 3 microns or less, about 2 microns or less, about 1 micron or less, about 500 nanometers or less. The pigment particles may have a D50 particle size of about 1 nanometer to about 8 microns, about 1 nanometer to about 5 microns, about 1 nanometer to about 4 microns, about 1 nanometer to about 3 microns, about 1 nanometer to about 2 microns, about 1 nanometer to about 1 micron, about 1 nanometer to about 500 nanometers, about 1 nanometer to about 100 nanometers, about 1 nanometer to about 50 nanometers, about 50 nanometers to about 5 microns, about 50 nanometers to about 1 micron, about 5 nanometers to about 5 microns, about 5 nanometers to about 4 microns, about 5 nanometers to about 3 microns, about 5 nanometers to about 2 microns, about 5 nanometers to about 1 micron, about 5 nanometers to about 500 nanometers, about 5 nanometers to about 100 nanometers, about 5 nanometers to about 50 nanometers, about 10 nanometers to about 5 microns, about 10 nanometers to about 4 microns, about 10 nanometers to about 3 microns, about 10 nanometers to about 2 microns, about 10 nanometers to about 1 micron, about 10 nanometers to about 500 nanometers, about 10 nanometers to about 100 nanometers, about 10 nanometers to about 50 nanometers, about 50 nanometers to about 5 microns, any value therein, or a range between any of these values.

The colorant comprises pigment particles having a size and shape such that the pigment particles do not block light. The staining composition may include pigment particles in the shape of spheres, chains, and/or irregularly shaped globes. Without being bound by theory, it is believed that spheres, chains, and irregularly shaped globes stack in a loose enough configuration that light is transmitted through the staining composition. However, it is believed that plate or flake shaped particles, like those found in mica, stack tightly leaving little to no room for light to be transmitted through the ink coating.

The staining composition may include a total amount of the colorant in an amount of about 9 wt. % to about 70 wt. %, about 9 wt. % to about 60 wt. %, about 9 wt. % to about 50 wt. %, about 9 wt. % to about 40 wt. %, about 10 wt. % to about 30 wt. %, about 10 wt. % to about 40 wt. %, about 10 wt. % to about 50 wt. %, or about 15 wt. % to about 30 wt. %, about 15 wt. % to about 40 wt. %, about 15 wt. % to about 50 wt. % of a colorant. Table 1 below presents examples of staining compositions according to the disclosure herein.

TABLE 1
Staining Compositions

| Color | Pigment | Binder | Diluent |
|---|---|---|---|
| Blue | Phthalo Blue Pigment 50 | None | DI water 50 wt. % |
| | wt. % | | |
| Blue | Phthalo Blue Pigment 20 | acrylic/styrene copolymer | DI water 35 wt. % |
| | wt. % | dispersion 45 wt. % | |
| Green | Phthalo Green Pigment 15 | acrylic/styrene copolymer | DI water 50 wt. % |
| | wt. % | dispersion 35 wt. % | |
| Violet | Violet Pigment 8-15 wt. % | acrylic/styrene copolymer | DI water 50 wt. % |
| | (e.g., carbazole violet or | dispersion 35 wt. % | |
| | quinacridone violet 8 wt. %) | | |
| Red | Red Pigment 50 wt. % | None | DI water 50 wt. % |
| Red | Red Pigment 5-20 wt. % | acrylic/styrene copolymer | DI water 15 wt. % |
| | (e.g., Fast Red 20 wt. %; DPP | dispersion 50 wt. % | |
| | Red 5 wt. %; or quinacridone | | |
| | red 5 wt. %) | | |
| Orange | Perinone Orange Pigment 50 | None | DI water 50 wt. % |
| | wt. % | | |
| Orange | Perinone Orange Pigment 25 | acrylic/styrene copolymer | DI water 50 wt. % |
| | wt. % | dispersion 25 wt. % | |
| Yellow | Yellow Pigment 15-30 wt. % | acrylic/styrene copolymer | DI water 40-50 wt. % |
| | | dispersion 25-35 wt. % | |
| Black | Carbon Black Pigment 18.65 | acrylic/styrene copolymer | DI water 50 wt. % |
| | wt. % | dispersion 15 wt. % | |
| Black | Lamp Black 25 wt. % | acrylic/styrene copolymer | DI water 25 wt. % |
| | | dispersion 50 wt. % | |

The colorant may include one or more of an organic pigment such as carbon black, phthalo blue, Colanyl® blue, ciphthalo green, diarylide yellow, organic yellow, high strength yellow, perinone orange, organic red, fast red, diketopyrrolopyrrole red, quinacridone red, quinacridone violet, carbazole violet, another pigment, and any combination thereof. Each of pigments may be either powder or pre-dispersed to make the colorant. The staining composition may include phthalo blue. The staining composition may include phthalo green. The staining composition may include diarylide yellow, organic yellow, high strength yellow, a mixture of both diarylide yellow and organic yellow, or any combination thereof. The staining composition may include phthalo green and diarylide yellow, organic yellow, or a mixture of both diarylide yellow and organic yellow. The staining composition may include phthalo green and organic yellow. The staining composition may include quinacridone violet, carbazole violet or a mixture of both quinacridone violet and carbazole violet. The staining composition may include fast red, diketopyrrolopyrrole (“DPP”) red, or a mixture of both fast red and diketopyrrolopyrrole red. The staining composition may include quinacridone red. The staining composition may include perinone orange. The staining composition may include carbon black.

A blue staining composition appears blue in color under reflected and/or transmitted light and includes at least one blue pigment and may contain a pigment of another color. The staining composition may include at least about 15 wt %, less than about 80 wt %, about 15 wt % to about 80 wt %, about 15 wt % to about 70 wt %, about 15 wt % to about 60 wt %, about 15 wt % to about 50 wt %, about 18 wt % to about 80 wt %, about 18 wt % to about 70 wt %, about 18 wt % to about 60 wt %, about 18 wt % to about 50 wt %, about 20 wt % to about 80 wt %, about 20 wt % to about 70 wt %, about 20 wt % to about 60 wt %, or about 20 wt % to about 50 wt % of a blue colorant. The blue colorant may comprise phthalo blue, ultramarine blue, Colanyl® blue, or other blue pigment, or a combination thereof. For example, the blue colorant may comprise phthalo blue.

An orange staining composition appears orange in color under reflected and/or transmitted light and includes at least one orange pigment and may contain a pigment of another color. The staining composition may include at least about 15 wt %, less than about 80 wt %, about 15 wt % to about 80 wt %, about 15 wt % to about 70 wt %, about 15 wt % to about 60 wt %, about 15 wt % to about 50 wt %, about 18 wt % to about 80 wt %, about 18 wt % to about 70 wt %, about 18 wt % to about 60 wt %, about 18 wt % to about 50 wt %, about 20 wt % to about 70 wt %, about 20 wt % to about 50 wt %, about 20 wt % to about 40 wt %, about 20 wt % to about 30 wt %, or any value within these ranges of an orange colorant (a colorant including an orange pigment). The orange colorant may comprise perinone orange, quinacridone gold, DNA orange, benzimidazolone orange, organic orange, dinitroaniline orange, diketo-pyrrolo-pyrrol orange, naphthol red, other orange, red or yellow pigment, or any combination thereof. For example, the orange colorant may comprise perinone orange.

A black staining composition appears black in color under reflected and/or transmitted light and includes at least one black pigment and may contain a pigment of another color. The staining composition may include a black colorant in an amount of about 1 wt % to about 50 wt %, about 1 wt % to about 45 wt %, about 1 wt % to about 40 wt %, about 1 wt % to about 30 wt %, about 1 wt % to about 20 wt %, about 5 wt % to about 50 wt %, about 5 wt % to about 45 wt %, about 5 wt % to about 40 wt %, about 5 wt % to about 30 wt %, about 5 wt % to about 20 wt %, about 10 wt % to about 50 wt %, about 10 wt % to about 45 wt %, about 10 wt % to about 40 wt %, about 10 wt % to about 30 wt %, about 10 wt % to about 20 wt %, about 15 wt % to about 50 wt %, about 15 wt % to about 40 wt %, about 15 wt % to about 30 wt %, about 15 wt % to about 20 wt %, or a value within any of these ranges. The black colorant may comprise lampblack, carbon black, other black pigment, or a combination thereof. For example, the black colorant may comprise carbon black.

A green staining composition appears green in color under reflected and/or transmitted light and includes at least one green pigment and may contain a pigment of another color. The staining composition may include a green colorant in an amount of about 1 wt % to about 50 wt %, about 1 wt % to about 45 wt %, about 1 wt % to about 40 wt %, about 1 wt % to about 30 wt %, about 1 wt % to about 20 wt %, about 5 wt % to about 50 wt %, about 5 wt % to about 45 wt %, about 5 wt % to about 40 wt %, about 5 wt % to about 30 wt %, about 5 wt % to about 20 wt %, about 10 wt % to about 50 wt %, about 10 wt % to about 45 wt %, about 10 wt % to about 40 wt %, about 10 wt % to about 30 wt %, about 10 wt % to about 20 wt %, about 15 wt % to about 50 wt %, about 15 wt % to about 40 wt %, about 15 wt % to about 30 wt %, about 15 wt % to about 20 wt %,or a value within any of these ranges . The green colorant may comprise phthalo green, Colanyl® green, unicert green, or other green pigment. For example, the green colorant may comprise phthalo green. When a yellow colorant is mixed with a green colorant to make a green staining composition, the staining composition may include a yellow colorant in an amount of about 1 wt % to about 10 wt %, about 1 wt % to about 8 wt %, about 1 wt % to about 6 wt %, about 1 wt % to about 5 wt %, about 2 wt % to about 10 wt %, about 2 wt % to about 8 wt %, about 2 wt % to about 6 wt %, or a value within any of these ranges. The yellow colorant which may be included in the green staining composition may comprise diarylide yellow, organic yellow, other yellow pigment, or a combination thereof.

A yellow staining composition appears yellow in color under reflected and/or transmitted light and includes at least one yellow pigment and may contain a pigment of another color. The yellow staining composition may include a yellow colorant in an amount of about 1 wt % to about 50 wt %, about 1 wt % to about 45 wt %, about 1 wt % to about 40 wt %, about 1 wt % to about 30 wt %, about 1 wt % to about 20 wt %, about 5 wt % to about 50 wt %, about 5 wt % to about 45 wt %, about 5 wt % to about 40 wt %, about 5 wt % to about 30 wt %, about 5 wt % to about 20 wt %, about 10 wt % to about 50 wt %, about 10 wt % to about 45 wt %, about 10 wt % to about 40 wt %, about 10 wt % to about 30 wt %, about 10 wt % to about 20 wt %, about 15 wt % to about 50 wt %, about 15 wt % to about 40 wt %, about 15 wt % to about 30 wt %, about 15 wt % to about 20 wt %, or a value within any of these ranges. The yellow staining composition may include a yellow colorant in an amount of about 20 wt %, about 25 wt %, about 30 wt %, about 35 wt %, or about 40 wt % of the composition. The yellow colorant may comprise diarylide yellow, organic yellow, yellow oxide, naphthol yellow, high strength yellow, other yellow pigment, such as Colanyl® yellow, other yellow pigment, or a combination thereof. For example, the yellow colorant may comprise diarylide yellow, organic yellow, or a combination thereof

A violet staining composition appears violet in color under reflected and/or transmitted light and includes at least one violet pigment and may contain a pigment of another color. The violet staining composition may include a violet colorant in an amount of about 1 wt % to about 50 wt %, about 1 wt % to about 45 wt %, about 1 wt % to about 40 wt %, about 1 wt % to about 30 wt %, about 1 wt % to about 20 wt %, about 5 wt % to about 50 wt %, about 5 wt % to about 45 wt %, about 5 wt % to about 40 wt %, about 5 wt % to about 30 wt %, about 5 wt % to about 20 wt %, about 10 wt % to about 50 wt %, about 10 wt % to about 45 wt %, about 10 wt % to about 40 wt %, about 10 wt % to about 30 wt %, about 10 wt % to about 20 wt %, about 15 wt % to about 50 wt %, about 15 wt % to about 40 wt %, about 15 wt % to about 30 wt %, about 15 wt % to about 20 wt %, or a value within any of these ranges. The violet colorant may comprise quinacridone violet, carbazole violet, diarylide violet, Colanyl® violet, other violet pigment, such as Flexonyl® violet, or a combination thereof. For example, the violet colorant may comprise quinacridone violet, carbazole violet, or a combination thereof

A red staining composition appears red in color under reflected and/or transmitted light and includes at least one red pigment and may contain a pigment of another color. The staining composition may include the red colorant in an amount of about 1 wt % to about 50 wt %, about 1 wt % to about 30 wt %, about 1 wt % to about 25 wt %, about 5 wt % to about 50 wt %, about 5 wt % to about 30 wt %, about 5 wt % to about 25 wt %, about 10 wt % to about 50 wt %, about 10 wt % to about 30 wt %, about 10 wt % to about 25 wt %, or a value within any of these ranges. The red colorant may comprise fast red, diketopyrrolopyrrole red, naphthol red, quinacridone magenta, quinacridone red, organic red, toluidine red, red oxide, or other red pigment, or a combination thereof. For example, the red colorant may comprise fast red, diketopyrrolopyrrole red, or a combination thereof.

### Binder

As used herein, the term “binder” means a polymer chain dispersion that helps to increase the staining composition's adherence to the tissue. The staining compositions disclosed herein may further include a binder. The binder may include an acrylic resin. For example, the acrylic resin may include acrylics, acrylates, methacrylate polymers or copolymers, styrene acrylics, styrene acrylates, or styrene methacrylate polymers or copolymers. The acrylic resin may include an alkali soluble styrene. The binder may include an acrylic styrene copolymer dispersion, such as a modified acrylic/styrene copolymer dispersion. The binder may include modified acrylic/styrene copolymer dispersion, optionally having a pH of about 8.0 to about 8.6, a total solids w/w of about 46% to about 48%, and/or a viscosity of about 250 to about 650 mPa·s at 25° C. The binder may include modified acrylic/styrene copolymer dispersion alone or in combination with one or more additional binders.

The staining composition may include greater than 0 wt %, at least about 10 wt %, at least about 13 wt %, at least about 15 wt %, at least about 20 wt %, at least about 25 wt %, less than about 80 wt %, less than about 75 wt %, less than about 70 wt %, less than about 60 wt %, less than about 50 wt %, less than about 40 wt % of the binder based on total weight of the composition or a range between any two of these values. For example, the staining composition may include greater than 0 wt % to about 50 wt %, greater than 0 wt % to about 35 wt %, greater than 0 wt % to about 35 wt %, about 0.5 wt % to about 35 wt %, about 0.5 wt % to about 75 wt %, about 13 wt % to about 50 wt %, about 30 wt % to about 70 wt %, about 14 wt % to about 75 wt %, about 16 wt % to about 70 wt %, about 12 wt % to about 47 wt %, about 13 wt % to about 46 wt % about 12 wt % to about 80 wt %, about 13 wt % to about 40 wt %, about 14 wt % to about 47 wt %, about 18 wt % to about 20 wt %, about 29 wt % to about 34 wt %, about 29 wt % to about 31 wt %, about 32 wt % to about 34 wt %, about 48 wt % to about 52 wt %, or about 72 wt % to about 77 wt % of the binder based on the total weight of the composition.

### Diluent

The staining composition may further include a diluent. The diluent may include water, such as deionized water, 10% neutral buffered formalin, alcohol, alkaline phosphatase stabilizing diluent, dispersing agents, or any combination thereof. The diluent may be present in the staining composition in an amount of about 40% to about 75% of the total weight of the composition. For example, the diluent may be included in an amount of about 40% to about 70%, about 40% to about 60%, about 40% to about 50%, about 50% to about 70%, about 60% to about 70% of the total weight of the composition, or a value within any of these ranges.

### Dye

The staining composition may further comprise a dye. As used herein, a “dye” means a solubilized color additive that adjusts the reflected light color appearance of the staining composition and adjusts the color imparted to the transport fluid via the stained tissue but does not affect the appearance of the tissue under transmitted light. The dye may be selected from a blue dye, green dye, violet dye, red dye, orange dye, yellow dye, indigo dye, black dye, any combination thereof. or any shade thereof.

The dye used in a staining composition herein may include food coloring, such as green food coloring, red food coloring, or yellow food coloring; phenazine based dyes, such as janus green and nigrosin; lactophenol cotton blue, oxazine dye, such as brilliant cresyl blue, Nile red, Nile blue or cinnabarine; thiazine dye, such as methylene blue and toluidine blue; triarylmethane dye, such as crystal violet; hematoxylin; natural red; xanthene dye, such as carbol rose bengal and eosin Y; a diozo dye, such as bismark brown; amber yellow keta dye; or other dyes such as protein stains, all-purpose dye, fabric dye, Rit® fuscia, FC™-navy blue; FC™-sky blue; FC™-grass green; FC™-black; FC™-Red; FC™-sunset yellow; FC™-lemon yellow; or a combination thereof.

The dye may be included in the staining composition in an amount of greater than 0% to about 15% by total weight of the composition. For example, the dye may be included in the staining composition in an amount of greater than 0% to about 10%, greater than 0% to about 9%, greater than 0% to about 8%, greater than 0% to about 5%, or a value between any of these ranges.

The staining compositions disclosed herein may have a pH of about 7.0 to about 9.0. For example, the pH of the staining composition is about 7.5 to about 9.0, about 7.75 to about 9.0, about 8.0 to about 9.0, about 7.5 to about 8.5, about 7.75 to about 8.5, about 7.5 to about 8.0, about 7.75 to about 8.0, or a value within any of the foregoing ranges.

### Viscosity

At room temperature, the staining composition may have a viscosity of about 15 KU (Krebs Units) or less when measured using ASTM D562. For example, the staining composition may have a viscosity of about 10 KU or less, about 1 KU to about 10 KU, about 2 KU to about 10 KU, or about 3 KU to about 10 KU, or a value within any of these ranges. At room temperature, the staining composition may have a viscosity of about 20 KU (Krebs Units) or less when measured using ASTM D562. For example, the staining composition may have a viscosity of about 10 KU or less, about 1 KU to about 10 KU, about 1.5 KU to about 10 KU, about 2 KU to about 10 KU, or about 3 KU to about 10 KU, or a value within any of these ranges.

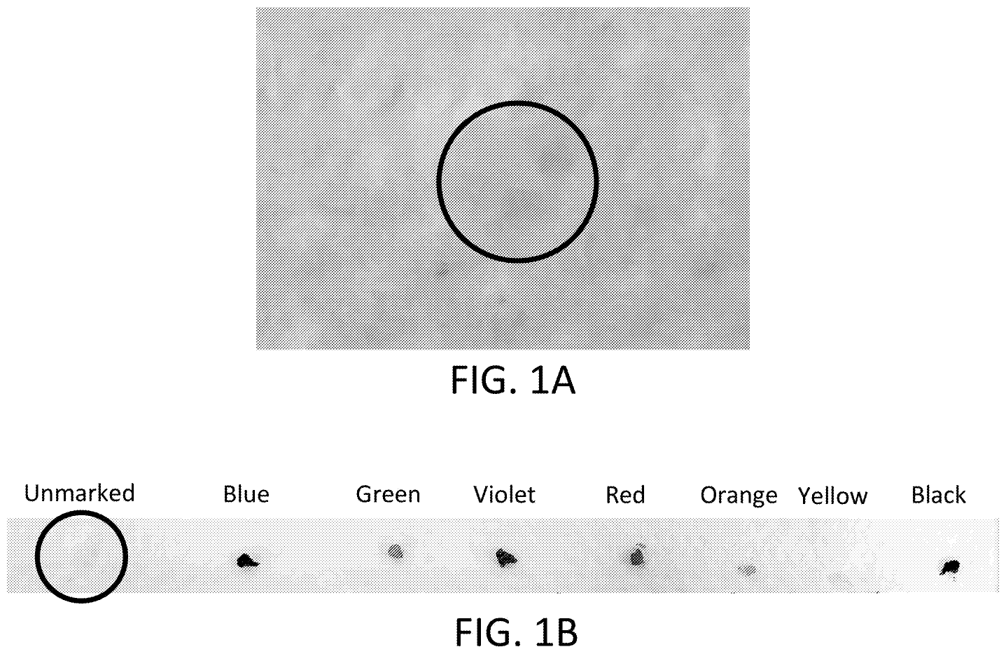

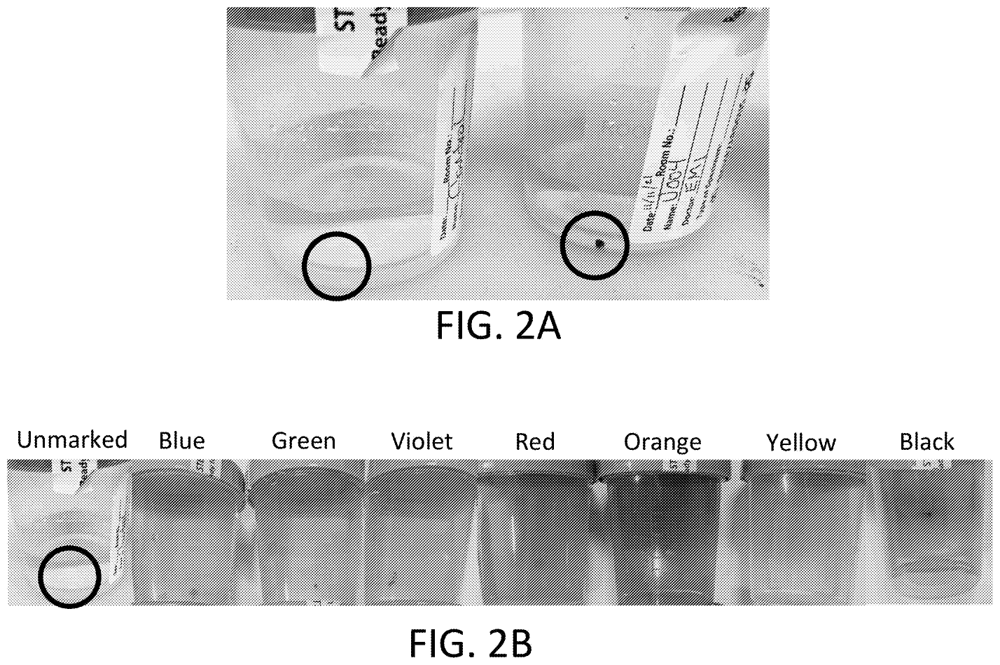

A staining composition which is too viscous may not allow (a) the staining composition to spread over the entire surface of the tissue, (b) the staining composition to be easily dispensed one uniform drop at a time, or (c) the staining composition to create a layer of color over the tissue so as not to obscure the presence of very small tissue fragments that could become hidden within a mound of the too viscous composition. A staining composition that has a viscosity that is too low (i.e. that is too thin) may result in a staining composition that separates and becomes heterogenous, resulting in inadequately stained tissue which cannot be easily identified and distinguished from other stained tissues, or insufficient contrast between the stained versus unstained tissue when compared under reflective or transmitted light. In addition, a high viscosity adversely affects the ability of the stained tissue to tint transport media (e.g. formalin) when such tissue is placed within. The staining composition must impart enough color to make color easily identifiable within the fluid; however, the transport medium must remain translucent enough for minute fragments to still be easily identified, and the stained tissue must provide enough contrast to allow minute fragments to be visualized and transferred for processing. Minute fragments that cannot be visualized are at great risk of going unnoticed and discarded. FIG. 1A is a non-limiting example of an unmarked tissue specimen. FIG. 2B is a non-limiting example of tissue specimens marked with staining compositions of different colors, as shown, i.e., blue, green, violet, red, orange, yellow or black. The tissues marked, or stained, with various staining compositions in FIG. 1B appear more brightly colored and easily distinguished than the unmarked tissue in FIG. 1A. The stained tissues may also be readily identifiable in a transport medium. The transport medium may be visibly tinted with the same color as the staining composition, allowing for correlation between the container, the stained tissue, and the patient.

### Sterile Compositions

The staining compositions described herein may be sterile allowing for use within sterile fields. Sterile staining compositions may be useful in the pathology lab when non-contamination of the tissue is important. Alternatively, the staining compositions described herein may be non-sterile, such as for use in non-sterile endoscopy suites or for colonoscopy.

### Additional Ingredients

The staining composition may also include a solvent, a polymer, an ionically charged substance, a preservative, a surfactant, or any combination thereof. Any known solvent, polymer, ionically charged substance, preservative, or surfactant for use in the art may be used. Examples may include aliphatic solvents, aromatic solvents, aliphatic and cyclic hydrocarbon solvents, electrolytes, polar materials, nonionic surfactants, anionic surfactants, low foam surfactants, polypropylene glycols, antimicrobials, and antifungals.

The staining compositions disclosed herein may further include a preservative. A preservative may be present in the staining composition in an amount of at least about 0.2 wt %, at least about 0.30 wt %, at least about 0.40 wt %. A preservative may be present in the staining composition in an amount of about 0.20 wt % to about 0.50 wt %, about 0.20 wt % to about 0.40 wt %, about 0.30 wt % to about 0.40 wt %, or about 0.25 wt % to about 0.4 wt %. The preservative may include 1,2-Benzisothiazolin-3-one (BIT), 5-Chloro-2-methyl-4-isothiazolin-3-one (CMIT), and/or 2-Methyl-4-isothiazolin-3-one (MIT), or a water-based dispersion of a blend of MIT, BIT and CMIT.

The staining compositions described herein may further include a solvent. A solvent may be present in about 25 wt % to about 35 wt % based on the total weight of the composition. The staining composition may include deionized water in an amount of about 25 wt % to about 35 wt %, about 30 wt % to about 34 wt %, or about 32 wt % to about 33 wt % based on the total weight of the composition.

### L*a*b* and Delta E

Often, colors of commercially available pathology inks are difficult to distinguish from one another. To perform effectively, each color must be both recognizable and distinguishable from other colors under both reflective light (ordinary lighting conditions, as when the staining composition is applied to tissue in the pathology lab or operating room), and under transmitted light (when light shines through from the opposite side, as when the tissue on a slide is placed under a microscope). When many of the commercially available pathology inks are viewed under reflective light, dark colors such as blue, violet, black, and green are often difficult to distinguish from one another and all appear to be black or similar to black. When applied to tissue and viewed on the slides under a microscope using transmitted light, difficulties are often encountered with distinguishing the yellow-orange, orange-red, blue-violet and red-violet staining compositions. Inaccurate identification of the color applied to the specimen can lead to confusion and medical errors. Such errors are egregious and can include: rejection of the specimen for analysis leading to repeat procedures, incorrect specimen identification, incorrect specimen anatomic source identification, incorrect diagnosis reported for the patient leading to unnecessary or inappropriate treatment of the patient.

Lab (L*, a*, b*) is a color model that is designed for the human eye. It is perceptually uniform, which means that the difference between two color values correlates with the perceived degree of difference between the two colors (the difference between colors is measured by their Euclidean distance). Therefore, gradients between two colors using the L*a*b color space will change very uniformly between the colors. Color differentiation and intensity under reflected light and transmitted light may be measured using L*a*b measurements, where L* indicates lightness of the color, a* is the position between green (negative values) and red/magenta (positive values), and b* is the position between blue (negative values) and yellow (positive values). L*a*b measurements disclosed herein were made using a single digital capture of all 7 compositions applied to tissue and a color picker software program to measure the L*a*b measurements.

Delta E is a metric for understanding how the human eye perceives differences among colors. Delta E is a standard measurement that quantifies the difference between two colors using L*a*b* coordinates. On a typical scale, the Delta E value will range from 0 to 100. A Delta E≤1.0 would not be perceptible by human eyes. At a Delta E between 1-2, differences in the colors would be perceptible through close observation. At a Delta E of 2-10, the differences between the colors would be perceptible at a glance. If the Delta E was measured to be 11-49, the two colors would be considered more similar than opposite whereas at a Delta E of 100, the two colors would be considered exact opposites.

As used herein, the terms “reflected light” or “reflected ambient light” refers to ambient lighting conditions where light reflects off a surface, such as light reflecting off the surface of the marked tissue in the pathology lab or operating room.

As used herein, the term “transmitted light” refers to conditions where the light source is located on the opposite side of the subject (in this case, the marked tissue) from the viewer and the subject is illuminated by light that is transmitted through it, such as when a stained-glass window is viewed from inside a building or where the marked tissue is illuminated from below by the microscope light as the user is viewing the tissue through the lens of a microscope.

For the staining compositions to perform well for their function, the average Delta E must be maximized under both lighting conditions (transmitted and reflected light); this is difficult because the lighting conditions can require opposing properties in the staining compositions. When compared to a staining composition of a different color, the staining composition described herein on tissue may have an average Delta E (“ΔE”) of at least 20 under reflected and/or transmitted light, optimally both. For example, when compared to a staining composition of a different color, the staining composition described herein has an average Delta E of 30 or greater on tissue, an average Delta E of 40 or greater, or an average Delta E of 50 or greater under reflected light and/or transmitted light. Tables 2, 3, 4, and 5 chart Delta E and average Delta E for staining compositions disclosed herein. Table 2 is a chart of Delta E and average Delta E of staining compositions when measured on tissue. Table 3 is a chart of Delta E and average Delta E of staining compositions when measured on slides. Table 4 is a chart of Delta E and average Delta E of staining compositions when measured in fluid. Table 5 is a chart of Delta E and average Delta E of staining compositions when measured on drawdowns.

TABLE 2
Delta E and Average Delta E of Staining Compositions on Tissue

| | | | | | | | | Average |
|---|---|---|---|---|---|---|---|---|
| | Blue | Green | Violet | Red | Orange | Yellow | Black | Delta E |
| Blue | | 60.50 | 21.60 | 72.50 | 101.10 | 119.80 | 44.00 | 69.92 |
| Green | 60.50 | | 54.80 | 70.60 | 91.90 | 83.40 | 30.00 | 65.20 |
| Violet | 21.60 | 54.80 | | 51.70 | 79.50 | 101.50 | 35.30 | 57.40 |
| Red | 72.50 | 70.60 | 51.70 | | 33.70 | 74.30 | 51.90 | 59.12 |
| Orange | 101.10 | 91.90 | 79.50 | 33.70 | | 58.10 | 81.10 | 74.23 |
| Yellow | 119.80 | 83.40 | 101.50 | 74.30 | 58.10 | | 92.40 | 88.25 |
| Black | 44.00 | 30.00 | 35.30 | 51.90 | 81.10 | 92.40 | | 55.78 |
| Average | 69.92 | 65.20 | 57.30 | 59.12 | 74.23 | 88.25 | 55.78 | |

| | |
|---|---|
| Delta E | Total Average: |
| | 67.13 |

TABLE 3
Delta E and Average Delta E of Staining Compositions on Slide

| | | | | | | | | Average |
|---|---|---|---|---|---|---|---|---|
| | Blue | Green | Violet | Red | Orange | Yellow | Black | Delta E |
| Blue | | 96.56 | 27.80 | 90.97 | 118.77 | 167.24 | 84.45 | 97.63 |
| Green | 96.56 | | 107.32 | 88.65 | 96.86 | 97.03 | 55.30 | 90.29 |
| Violet | 27.80 | 107.32 | | 77.08 | 106.25 | 168.34 | 79.63 | 94.40 |
| Red | 90.97 | 88.65 | 77.08 | | 29.27 | 107.41 | 58.11 | 75.25 |
| Orange | 118.77 | 96.86 | 106.25 | 29.27 | | 88.89 | 73.78 | 85.64 |
| Yellow | 167.24 | 97.03 | 168.34 | 107.41 | 88.89 | | 120.26 | 124.86 |
| Black | 84.45 | 55.30 | 79.63 | 58.11 | 73.78 | 120.23 | | 78.26 |
| Average | 97.63 | 90.29 | 94.40 | 75.25 | 85.64 | 124.86 | 78.59 | |
| Delta E | | | | | | | | |

Total Average:
92.33

TABLE 4
Delta E and Average Delta E of Staining Compositions on Fluid

| | | | | | | | | Average |
|---|---|---|---|---|---|---|---|---|
| | Blue | Green | Violet | Red | Orange | Yellow | Black | Delta E |
| Blue | | 46.18 | 15.16 | 50.02 | 64.10 | 65.12 | 36.35 | 46.16 |
| Green | 46.18 | | 57.49 | 75.24 | 79.02 | 59.21 | 41.23 | 59.73 |
| Violet | 15.16 | 57.49 | | 38.68 | 38.67 | 54.37 | 42.67 | 41.17 |
| Red | 50.02 | 75.24 | 38.68 | | 19.21 | 54.38 | 42.67 | 46.70 |
| Orange | 64.10 | 79.02 | 38.67 | 19.21 | | 47.10 | 48.91 | 49.50 |
| Yellow | 65.12 | 59.21 | 54.37 | 54.38 | 47.10 | | 58.06 | 56.37 |
| Black | 36.35 | 41.23 | 42.67 | 42.67 | 48.91 | 58.06 | | 44.98 |
| Average | 46.16 | 59.73 | 41.17 | 46.70 | 49.50 | 56.37 | 44.98 | |
| Delta E | | | | | | | | |

Total Average:
49.23

TABLE 5
Delta E and Average Delta E of Staining Compositions on Drawdowns

| | | | | | | | | Average |
|---|---|---|---|---|---|---|---|---|
| | Blue | Green | Violet | Red | Orange | Yellow | Black | Delta E |
| Blue | | 139.50 | 20.60 | 101.60 | 131.64 | 163.80 | 70.12 | 104.54 |
| Green | 139.50 | | 122.41 | 103.80 | 124.57 | 75.42 | 82.49 | 108.03 |
| Violet | 20.60 | 122.41 | | 89.48 | 122.52 | 149.53 | 49.53 | 92.35 |
| Red | 101.60 | 103.80 | 89.48 | | 36.99 | 84.20 | 72.87 | 81.49 |
| Orange | 131.64 | 124.57 | 122.52 | 36.99 | | 79.77 | 109.24 | 100.79 |
| Yellow | 163.80 | 75.45 | 149.53 | 84.20 | 79.77 | | 118.80 | 111.93 |
| Black | 70.12 | 82.49 | 49.53 | 72.87 | 109.24 | 118.80 | | 83.84 |
| Average | 104.54 | 108.03 | 92.35 | 81.49 | 100.79 | 111.93 | 83.84 | |
| Delta E | | | | | | | | |

Total Average:
97.57

For example, when comparing yellow and red, yellow and orange, or orange and red colored compositions on tissue, the average Delta E may be greater than about 30, such as greater than about 50, or greater than about 75, or greater than about 80 under reflected and/or transmitted light. When comparing blue and violet, blue and green, or green and violet colored compositions on tissue, the average Delta E may be greater than about 30, greater than about 20, at least about 50, or at least about 60, under reflected and/or transmitted light. When comparing red and violet, or blue and violet colored compositions on tissue, the average Delta E may be greater than about 20, greater than about 75, greater than about 50, greater than about 35, or greater than about 30, under reflected and/or transmitted light. The staining compositions on tissue may have an average ΔE of at least about 20, at least about 30, at least about 40, at least about 50, at least about 60, at least about 75, or at least about 80 in both transmitted light and reflected light.

L*a*b* values were used to compute the Delta E using the following formula:

ΔE*_{ab}=\sqrt{ΔL*²+Δa*²+Δb*²}

L*a*b measurements disclosed herein of the compositions were made via a drawdown bar used to apply a 1.5 mL uniform film to identical drawdown cards. The staining composition was allowed 24 hours to dry and then the L*a*b* reading was obtained from a defined area on each card under identical ambient reflected lighting conditions. L*a*b measurements disclosed herein of the compositions on tissue and fluid were made via using a single digital capture of all 7 compositions and a color picker software program to record the L*a*b measurements. For transmitted light, staining compositions were applied to fresh tissue per the standard IFU, processed, cut and turned in H&E slides. The slides were then photographed using constant lighting conditions. A color picker was then used to obtain the L*a*b* readings.

### Transport Medium

Once stained, the tissue may be placed in a transport medium. As used herein, the term “transport medium” means a solution used to preserve biological specimens during transport. When the stained tissue is submerged into the transport medium, small amounts of colorant from the stained tissue migrate from tissue into the fluid, which then becomes visibly tinted with the same color.

The transport medium may comprise formalin, such as phosphate buffered formalin, alcoholic formalin, or zinc formalin, formal calcium, formal saline, formal acetic alcohol, or any combination thereof. The transport medium may be visibly tinted within about 1.5 minutes or less, about 1 minute or less, about 50 seconds or less, about 30 seconds or less after the stained composition is placed within the transport medium. When both the stained tissue and the transport medium in the specimen container are the same color, it significantly reduces the chances of cross-contamination of samples during transport. FIGS. 2A and 2B are non-limiting examples of images of unmarked tissue specimen (FIG. 2A) and marked tissue specimens (FIG. 2B) in formalin transport medium. The marked, or stained tissues in FIG. 2B are readily identifiable in the transport medium and the transport medium is visibly tinted with the same color (or substantially the same) as the staining composition, allowing for correlation among the container, the stained tissue, and the patient record.

### Container

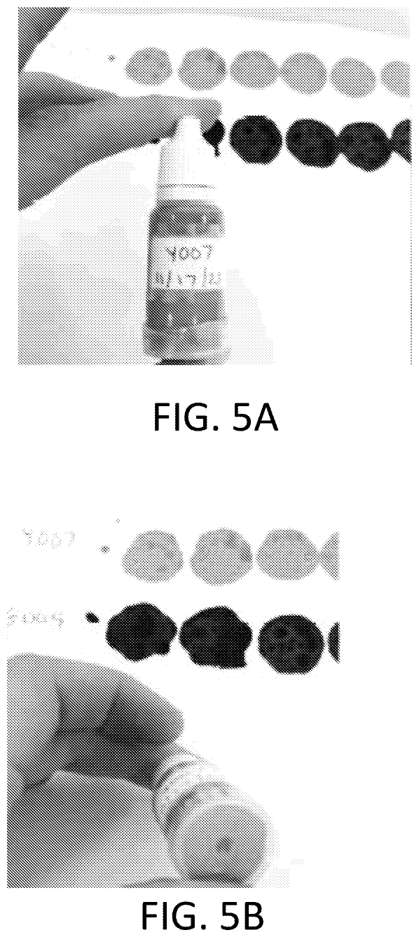

The staining composition may be disposed in a container, for example, for sale, storage, etc. The container may include a stamp pad or other means of indicating the color of the staining composition. The container may further include an applicator tip or a dropper tip. The dropper tip or applicator tip may be attached at a lid of the container. The applicator tip may comprise a tapered opening, a brush or a sponge tip. The stamp pad may allow a means of identifying the color of the staining composition, such as stamping an ink of the same color, or stamping the name, letter indicator, or other identification of the color. The stamp pad may include any material suitable for the purpose, such as a sponge, felt, foam, rubber, a brush, a roller, or the like. FIGS. 5A and 5B is a non-limiting example of a container having a stamp pad on the bottom.

### Tissue Staining System

The staining compositions described herein may be used in a tissue staining system. The tissue staining system may include at least two different colors of the staining composition that can (a) stain a tissue, (b) tint formalin when stained tissue is placed within, and (c) visibly differentiate the tissue macroscopically in reflected light, and microscopically on stained slides. For example, the tissue staining system may include at least two, at least three, at least four, at least five, at least six, or at least seven or more different colors of staining composition described herein.

The staining system may include a plurality of staining compositions, each having an average Delta E (“ΔE”) of at least about 15, or at least about 20, on tissue, under both reflected and transmitted light when compared to a staining composition of a different color. For example, the staining system may include at least four colors of the staining composition, each having an average Delta E (“ΔE”) of at least about 15, or at least about 20, on tissue, under both reflected and transmitted light when compared to a staining composition of a different color. The system may further include the container described herein including a means of indicating the color of the staining composition.

### Tissue Staining Kit

The staining composition described herein may be included in a kit. The kit may include a plurality of staining compositions, such as staining compositions of a plurality of colors. The kit may further include a fixture to house and/or display containers of the variously colored staining compositions, and/or instructions for use of the staining compositions. The container may include a stamp or other means to identify the color of the staining composition.

### Method of Staining a Tissue

A method of staining a tissue is also disclosed, the method comprising contacting a tissue with a staining composition comprising: a colorant comprising pigment particles having a D50 particle size of about 5 microns or less and a liquid carrier; and a diluent, wherein the composition has a viscosity of about 10 Krebs Units or less.

The method may include contacting the tissue with about one to about ten drops of the staining composition. The method may include contacting the tissue with about one to about four drops of the staining composition. The method may include contacting the tissue with about 0.06 mL to about 0.7 mL of the staining composition. The method may include contacting the tissue with the staining composition in an amount of about 0.06 mL to about 0.6 mL, about 0.06 mL to about 0.5 mL, about 0.06 mL to about 0.4 mL, about 0.06 mL to about 0.3 mL, about 0.06 mL to about 0.29 mL, or a value within any of these ranges.

The method of staining further includes placing the stained tissue into a container including a transport medium, whereby the transport medium is also tinted with the staining composition.

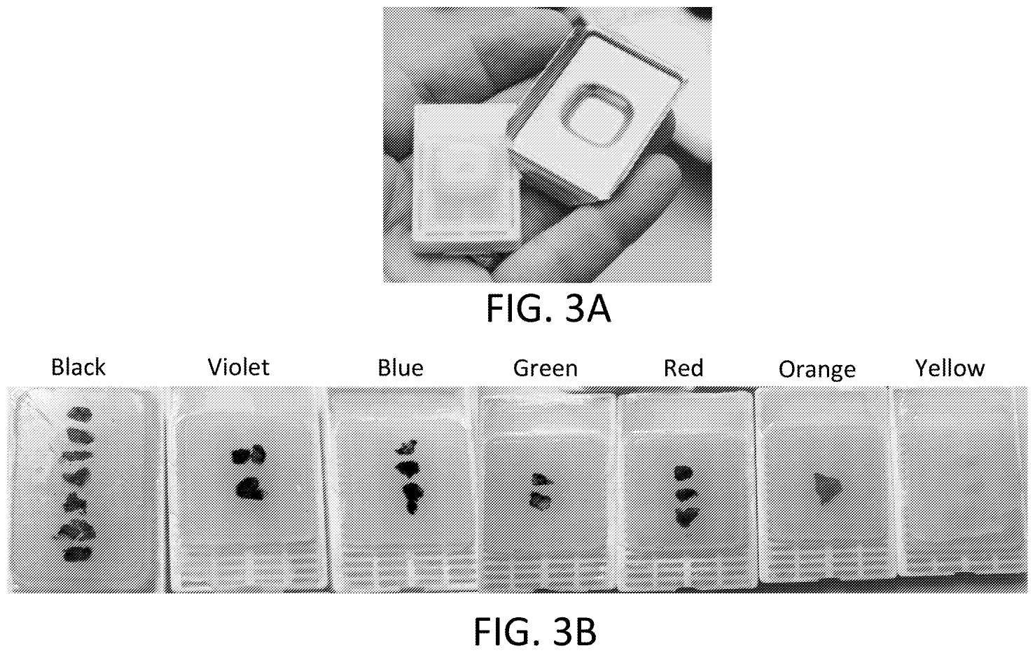

The method of staining a tissue may include contacting the tissue with the staining composition at the procedure room. Application of the staining composition at point of collection makes the tissue more visible and distinguishable, making it obvious that there is a specimen in the container. The method may further comprise recording the color of the staining composition onto a document that identifies the patient, the procedure, doctor, and/or the anatomic source of the tissue within the patient. The method may further comprise recording the color of the staining composition used onto a computer system. The computer system may include the patient record, the hospital/clinic computer system, and/or the laboratory computer system. The method of staining a tissue may further include recording the color identified on the tissue in the macroscopic report. The method of staining a tissue may further include embedding the tissue in paraffin for microtomy and histological analysis. FIGS. 3A and 3B are non-limiting examples of images of unmarked (FIG. 3A) and marked (FIG. 3B) tissue specimens embedded in paraffin. Each color of the staining composition clearly differentiates each tissue specimen, and the visible color associates it with a patient record.

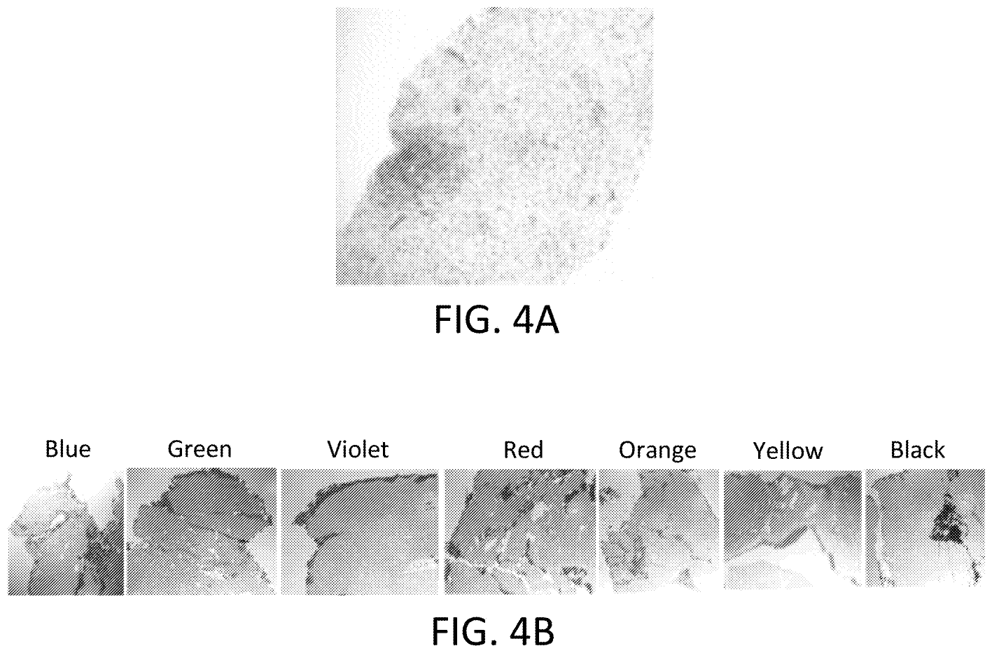

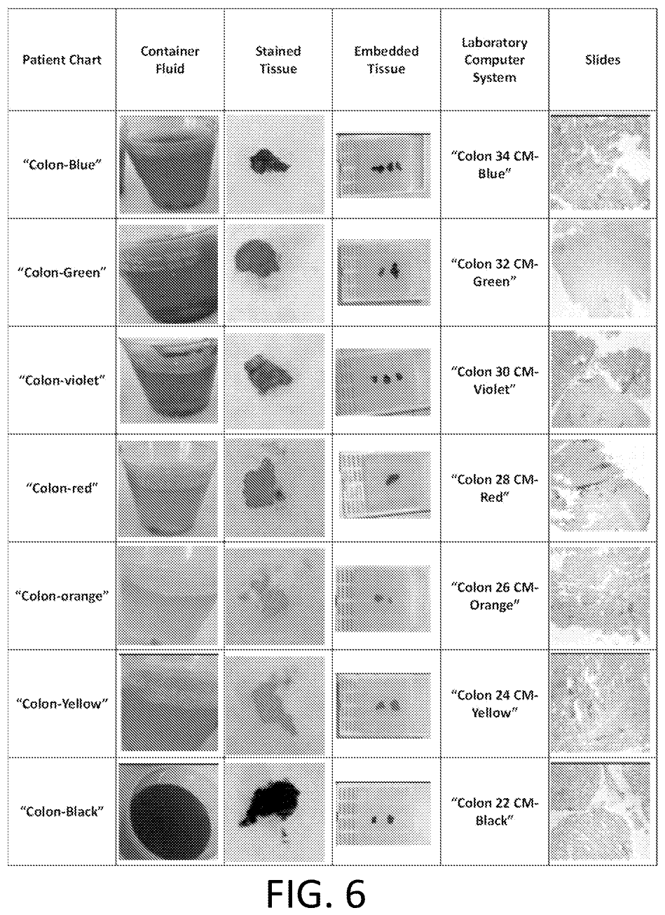

The method of staining a tissue may further include examining the stained tissue under transmitted light, wherein the staining composition does not obscure the tissue histology or hinder the diagnosis processes and recording the color identified in the final diagnosis. Along the entire chain of custody and steps of processing, the color listed on paperwork, the color listed on the patient record, the color described in the macroscopic and microscopic description, and the visual inspection of the tissue color both grossly under reflected light and microscopically under transmitted light may be compared to verify the tissue identity. FIG. 4A is an image of an unmarked microscopic tissue slide and FIG. 4B includes images of tissue on microscopic tissue slides marked with different colored staining compositions. While the unmarked tissue shown in FIG. 4A has no color identification, the various colors from the marked, or stained, tissues in FIG. 4B add an identifier that is recognizable on the slide, making it easy to identify patient and anatomical site, and identify, correct, and prevent errors in the proper identification of the tissue. This process not only prevents and identifies errors, it also provides confidence to the health care team when unexpected results occur. FIG. 6 illustrates a chart of such a system indicating how the color of the staining composition may be used throughout the chain of custody and tissue processing. The use of the staining compositions in this way establishes an uninterrupted continuum of identification from the time of excision to the time of pathology report. Further, the staining and identification system using the staining compositions disclosed herein facilitates accurate specimen handling and by identifying cross-contamination of specimens from other patients or anatomical locations, mislabeling of the specimen, and preventing loss of the specimen itself.

### Method of Preparation

The staining compositions may be prepared by charging the diluent to the vessel, mixing at slow speed, adding the binder if indicated, adjusting the speed as necessary to pull a vortex, adding the dye if indicated, adding the colorant, adjusting the speed to maintain the vortex, adding any additional components, and allowing to mix for 15 minutes.

The method of making the staining compositions described herein may further comprise subjecting the staining compositions to gamma radiation to produce a sterile product. The gamma radiation may be applied at about 20 kiloGrays (kGy) to about 60 kGy, about 25 kiloGrays (kGy) to about 60 kGy, about 25 kiloGrays (kGy) to about 45 kGy, about 27 kGy to about 39 kGy, or about 33 kGy.

It must also be noted that as used in the specification and in the appended claims, the singular forms “a”, “an”, and “the” include plural references unless the context clearly dictates otherwise. Thus, for example, reference to “a colorant” is a reference to one or more colorants and equivalents thereof known to those skilled in the art, and so forth. Also, the terms “includes” and/or “including,” when used in this specification, specify the presence of stated features, elements, and/or components, but do not preclude the presence or addition of one or more other features, steps, operations, elements, components, and/or groups thereof.

As used herein, the term “about” means plus or minus 10% of the numerical value of the number with which it is being used. Therefore, about 50% means in the range of 45%-55%.

As used herein, the term “optional” or “optionally” means that the subsequently described event or circumstance may or may not occur, and that the description includes instances where the event occurs and instances where it does not.

As used herein, the term “room temperature” means an indoor temperature of from about 20° C. to about 25° C. (68 to 77° F.).

Throughout the specification of the application, various terms are used such as “primary,” “secondary,” “first,” “second,” and the like. These terms are words of convenience in order to distinguish between different elements, and such terms are not intended to be limiting as to how the different elements may be utilized.

### EXAMPLES

### Example 1

The staining compositions in Table 6 below were prepared by charging the diluent to the vessel, mixing at slow speed, adding the binder if indicated, adjusting the speed as necessary to pull a vortex, adding the dye if indicated, adding the pigments (as colorants), adjusting the speed to maintain the vortex, adding any additional components, and allowing to mix for greater than 15 minutes.

TABLE 6
Results of staining compositions on tissue visualization, fluid color, and on slide

| | | | | Tissue | Fluid | |
|---|---|---|---|---|---|---|
| Pigment | Dye | Binder | Diluent | Visualization | Color | Slide |
| phthalo blue 50% | None | None | DI water | 5 | 5 | 5 |
| | | | 50% | | | |
| phthalo blue 15% | None | acrylic/styrene | DI water | 5 | 5 | 5 |
| | | copolymer | 50% | | | |
| | | dispersion 35% | | | | |
| phthalo blue 15% | brilliant | None | DI Water | 5 | 5 | 5 |
| | cresyl blue | | 75% | | | |
| | dye 10% | | | | | |
| phthalocyanine 15% | None | acrylic/styrene | DI Water | 5 | 5 | 5 |
| | | copolymer | 50% | | | |
| | | dispersion 35% | | | | |
| phthalo green 50% | None | NONE | DI Water | 5 | 5 | 5 |
| | | | 50% | | | |
| polychlorinated | green food | acrylic/styrene | DI Water | 5 | 5 | 4 |
| copper-phthalocyanine | coloring 10% | copolymer | 50% | | | |
| 15% | | dispersion 35% | | | | |
| carbazole violet 15% | NONE | acrylic/styrene | DI Water | 5 | 4 | 5 |
| | | copolymer | 50% | | | |
| | | dispersion 35% | | | | |
| dioxazine violet 15% | grape purple | acrylic/styrene | DI Water | 4 | 4 | 5 |
| | dye 10% | copolymer | 40% | | | |
| | | dispersion 35% | | | | |
| red pigment 50% | red dye 10% | None | DI Water | 5 | 5 | 5 |
| | | | 40% | | | |
| Fast red 20%; | red dye 10% | acrylic/styrene | DI Water | 5 | 5 | 5 |
| diketopyrrolopyrrole | | copolymer | 40% | | | |
| pigment 10% | | dispersion 20% | | | | |
| perinone orange 25% | | acrylic/styrene | DI Water | 5 | 5 | 5 |
| | | copolymer | 50% | | | |
| | | dispersion 25% | | | | |
| perinone orange 40% | sunset yellow | None | DI Water | 5 | 5 | 5 |
| | dye 10% | | 50% | | | |
| dairylide yellow 25% | | acrylic/styrene | DI Water | 5 | 5 | 5 |
| | | copolymer | 50% | | | |
| | | dispersion 25% | | | | |
| yellow pigment 15% | amber yellow | acrylic/styrene | DI Water | 5 | 5 | 5 |
| | keta dye 10% | copolymer | 50% | | | |
| | | dispersion 35% | | | | |
| black pigment 50% | | None | DI Water | 5 | 5 | 5 |
| | | | 50% | | | |
| Carbon black 25% | | acrylic/styrene | DI Water | 5 | 5 | 5 |
| | | copolymer | 50% | | | |
| | | dispersion 25% | | | | |

### Rating Scales

In a given area, an ideal composition is a score of 5, an excellent composition is a score of 4, a mediocre composition has a score of 3, an inferior composition has a rating of 2, and a rejected composition has a rating of 1.

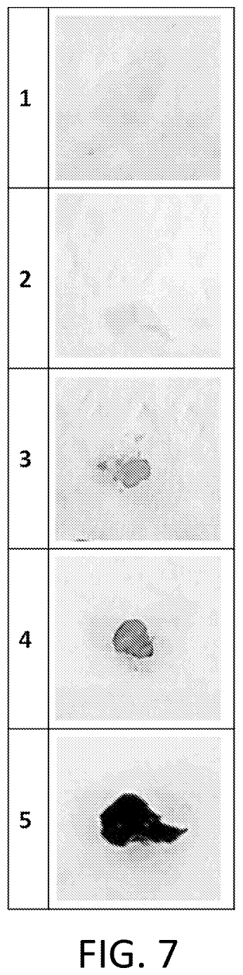

Tissue Visualization: This scale measured the macroscopic visualization of the stained tissue. If the composition staining the tissue is too light the stain is not easily recognized, if the staining is too dark the tissue cannot be easily distinguished from other dark colors. See FIG. 7 for a more detailed explanation of a visualization scale that may be used. In this example of a visualization scale, numeral 1 is used to identify that no identifiable ink is observed on the tissue; the composition has not adhered to the tissue. Numeral 2 is used to identify a minimal presence of ink on the tissue. This is distinguished by a slight tint on the tissue, but the color is not readily identifiable. Numeral 3 is used to identify a moderate presence of ink on the tissue. This is distinguished by tissue being partially or lightly colored. Numeral 4 is used to identify an excellent adherence of ink to the tissue. This is distinguished by a full coverage of the composition on the tissue. Numeral 5 indicates a superior adherence of ink to the tissue. This is distinguished by a full coverage of the tissue with the color and composition color is easily identifiable.

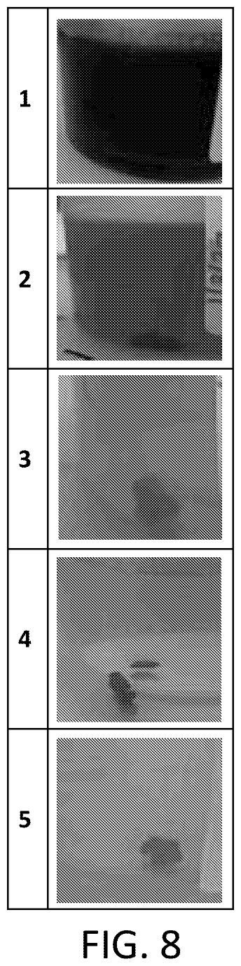

Fluid Color: This scale measured the macroscopic staining of the transport media once the stained tissue is placed therein. If the transport media staining is too light, the stain is not easily recognized, if the staining is too dark the tissue cannot be easily identified within the fluid and may be lost. See FIG. 8 for a more detailed explanation of a fluid color scale used. Numeral 1 is used to identify a heavy presence of ink in formalin; formalin is darkly colored with the ink and the tissue within the container cannot be easily identified. Numeral 2 is used to identify a significant presence of ink in formalin; formalin is substantially colored with the ink obscuring the view of the tissue within the container. Numeral 3 is used to identify little presence of ink in formalin; light color appears in the formalin. Numeral 4 is used to identify a slight or no apparent presence of ink in formalin; minimal identifiable coloring of formalin and clear view of tissue. Numeral 4 is used to identify no presence of ink in formalin; no identifiable coloring of the formalin and the tissue is easily identified.

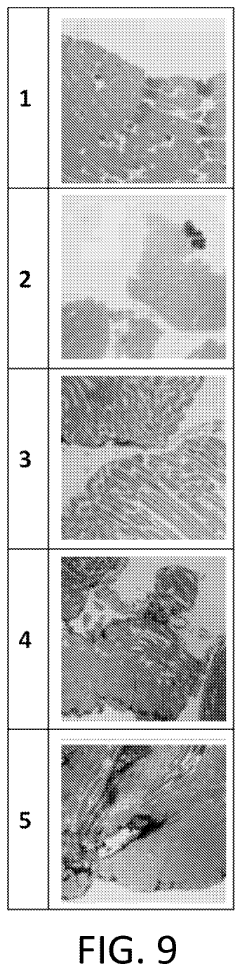

Slide Visualization: This scale measured the microscopic visualization of the stained tissue under transmitted light. Adherence must translate to easy visibility and identification under the microscope when the tissue sample is put on a slide and viewed microscopically for the range of low (2.5×) to high (60×) power. See FIG. 9 for a more detailed explanation of a slide visualization scale that may be used. In this example, numeral 1 is used to identify that no identifiable ink is observed on the tissue; the composition has not adhered to the tissue. Numeral 2 is used to identify a minimal presence of ink on the tissue. This is distinguished by a slight tint on the tissue, but the color is not readily identifiable. Numeral 3 is used to identify a moderate presence of ink on the tissue. This is distinguished by the tissue being partially or lightly colored. Numeral 4 is used to identify an excellent adherence of ink to the tissue. This is distinguished by full coverage of the tissue by the composition. Numeral 5 is used to identify a superior adherence of ink to the tissue. This is distinguished by full coverage of the tissue by the composition and composition color is easily identifiable.

As shown in Table 6, the exemplary staining compositions disclosed herein had excellent or ideal values for tissue visualization, fluid color, and slide visualization.

While there have been described what are presently believed to be various aspects and certain desirable embodiments of the disclosure, those skilled in the art will recognize that changes and modifications may be made thereto without departing from the spirit of the disclosure, and it is intended to include all such changes and modifications as fall within the true scope of the disclosure.

1. A tissue staining composition comprising: a colorant comprising pigment particles having a D50 particle size of about 5 microns or less and a liquid carrier; and a diluent; wherein the composition has a viscosity of about 10 Krebs Units or less.

2. The tissue staining composition of claim 1, wherein the colorant is in an amount of about 15% to about 50% by weight of the composition.

3. The tissue staining composition of claim 1, further comprising a binder.

4. The tissue staining composition of claim 3, wherein the binder comprises an acrylic resin, such as an alkali soluble styrene.

5. (canceled)

6. (canceled)

7. The tissue staining composition of claim 1, wherein the diluent is present in an amount of about 40% to about 75% by weight of the composition.

8. The tissue staining composition of claim 1, further comprising a dye.

9. The tissue staining composition of claim 8, wherein the dye is in an amount of greater than about 0% to about 10% by weight of the composition.

10. The tissue staining composition of claim 1, wherein the composition has a pH of about 7.75 to about 9.0.

11. The tissue staining composition of claim 1, further comprising a solvent, a polymer, an ionically charged substance, a preservative, a surfactant, or any combination thereof.

12. The tissue staining composition of claim 1, wherein, when stained on tissue and compared to tissue stained with a second staining composition of a different color, the staining composition has a Delta E of at least about 20 in reflected and/or transmitted light.

13. (canceled)

14. (canceled)

15. A method of staining a tissue, the method comprising
contacting the tissue with a staining composition comprising a diluent and a colorant comprising pigment particles having a D50 particle size of about 0.1 μm or less and a liquid carrier; wherein the staining composition has a viscosity of about 10 Kreb Units or less; and wherein the tissue is 1 cm or less at its greatest dimension.

16. The method of claim 15, wherein the staining composition further comprises a binder.

17. (canceled)

18. The method of claim 15, wherein the tissue is contacted with about 0.06 mL to about 0.29 mL of the staining composition.

19. The method of claim 15, further comprising placing the stained tissue in a formalin solution, whereby the formalin solution is visibly tinted with the staining composition.

20. The method of claim 15, further comprising indicating on a document the color of the staining composition with which the tissue was marked.

21. (canceled)

22. The method of claim 15, wherein the colorant is in an amount of about 15% to about 50% by weight of the composition.

23. The method of claim 16, wherein the binder is present and comprises an acrylic resin.

24. (canceled)

25. (canceled)

26. The method of claim 15, wherein the diluent is present in an amount of about 40% to about 75% by weight of the composition.

27. (canceled)

28. (canceled)

29. The method of claim 15, wherein contacting the tissue with a staining composition is done at the time of tissue collection.

30. A kit comprising a bottle having a staining composition disposed therein, wherein the staining composition comprises: a diluent, and a colorant comprising pigment particles having a D50 particle size of about 5 microns or less and a liquid carrier; and instructions for using the same.

31.-45. (canceled)
